(19) United States
(12) Patent Application Publication
(10) Pub. No.: US 2023/0274168 A1
(43) Pub. Date: Aug. 31, 2023

(54) QUANTIFYING THE HUMAN-LIKENESS OF ARTIFICIALLY INTELLIGENT AGENTS USING STATISTICAL METHODS AND TECHNIQUES

(71) Applicants: ADVANCED MICRO DEVICES, INC., Santa Clara, CA (US); ATI TECHNOLOGIES ULC, MARKHAM, CA (US)

(72) Inventors: Ian Charles COLBERT, Santa Clara, CA (US); Mehdi SAEEDI, Markham (CA); Gabor SINES, MARKHAM (CA); Thomas Daniel PERRY, Santa Clara, CA (US)

(21) Appl. No.: 17/682,832

(22) Filed: Feb. 28, 2022

(51) Int. Cl. G06N 5/04

(52) U.S. Cl. CPC G06N 5/043

(57) ABSTRACT

An apparatus includes a processor configured to determine a first distribution associated with an artificial agent based on behavior associated with the artificial agent and a second distribution based on behavior of a user. The processor is further configured to generate a human-likeness similarity measurement by comparing the first distribution to the second distribution and modify the behavior of the artificial agent in response to the similarity measurement failing to satisfy a similarity threshold.

### BACKGROUND

One mechanism for implementing artificial intelligence (AI) is through artificial agents, which are non-human entities that have knowledge of their environment and autonomously perform actions to achieve a goal(s). Artificial agents are becoming an integral part of many different technologies and industries. For example, vehicles implement artificial agents to perform autonomous driving operations, video games implement artificial agents as non-playable characters (NPC), and factories implement robots as artificial agents to autonomously perform various actions. In many instances, artificial agents are trained using various techniques to emulate human behavior in their environments. Therefore, evaluating the human-likeness of an agent's behavior often is an important part of the design and development of artificial agents.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of an operating environment for evaluating and quantifying similarities between artificial agent behavior and human counterpart behavior in accordance with some embodiments.

FIG. 2 is a flow diagram illustrating an overall example method for modifying the behavior of an artificial agent based on a similarity measurement quantifying the human-likeness of the artificial agent in accordance with some embodiments.

FIG. 3 is a flow diagram illustrating an example method for evaluating and quantifying similarity between artificial agent behavior and human counterpart behavior in accordance with some embodiments.

FIG. 4 is a diagram illustrating examples of a top-down projection representation of artificial agent and human counterpart behavior in accordance with some embodiments.

FIG. 5 is a flow diagram illustrating an example method for performing a two-sample hypothesis test for evaluating and quantifying similarity between artificial agent behavior and human counterpart behavior at block 310 of FIG. 3 in accordance with some embodiments.

FIG. 6 is a diagram illustrating an example of artificial agent behavior analysis results in accordance with some embodiments.

FIG. 7 is a table illustrating how a hyperparameter can be adjusted to control the sensitivity of the two-sample hypothesis test performed at block 310 of FIG. 3 in accordance with some embodiments.

FIG. 8 is a block diagram of a processing system in accordance with some embodiments.

### DETAILED DESCRIPTION

Developing artificial agents capable of learning complex human-like behaviors is a goal of artificial intelligence research. Advancements in machine learning techniques, such as deep reinforcement learning, have enabled the development of highly skilled artificial agents capable of complex intelligent behavior. For example, in video games, artificial agents are increasingly deployed as non-playable characters (NPCs) that are designed to emulate human behavior and enhance the experience of human players. Although the design and development of highly skilled artificial agents has progressed, quantifying the human-likeness of artificial agents remains a challenge. For example, the believability of an artificial agent's behavior is often measured solely by the agent's proficiency at a given task, but proficiency alone is not sufficient to measure human-like behavior.

Various approaches have attempted to quantify/measure the believability of artificial agents' behavior but each of these approaches have various drawbacks. For example, one approach for evaluating artificial agent behavior involves human assessment (e.g., a Turing Test) of the agents. However, this approach is not practical for most environments given the speed, scalability, and cost limitations of human assessment. Another approach implements environment (domain) specific tests that rely on rules or heuristics to detect human-like behavior of agents. This approach requires a large amount of manual effort by domain experts, which is time consuming and costly. Also, the environment specific tests tend to coarsely evaluate differences in results rather than directly evaluating agent behavior and fail to capture fine-grained details of human-likeness (e.g., detecting cyclic behavior, counting collisions, or measuring the steps taken to achieve a goal, etc.). Other approaches implement machine learning to assess the behavior of artificial agents. However, the machine learning models are usually fit to a specific environment and are not easily generalizable.

The present disclosure describes embodiments of systems and methods for overcoming various issues, including computational cost, efficiency, and accuracy, associated with conventional techniques for quantifying the human-likeness of artificial agent behavior. As described in greater detail below, the similarity between the behavior of an artificial agent(s) and the behavior of a human counterpart(s) is evaluated and quantified using a non-parametric two-sample hypothesis testing technique. The non-parametric two-sample hypothesis testing technique uses a distribution of an artificial agent's state-action pairs (e.g., a trajectory) to determine if the behavior of the agent is human-like and further quantifies how human-like the behavior is. For example, the similarity of their respective behaviors is compared using a distribution of a human behavior sequence and a distribution of an artificial intelligence behavior sequence associated with the same or similar task/goal. The two-sample hypothesis testing technique outputs a similarity measurement quantifying the human-likeness of the artificial agent's behavior.

An advantage of the artificial agent behavior analysis techniques described herein is that they are domain/environment agnostic and are applicable to multiple different abilities associated with intelligent behavior unlike conventional analysis techniques, such as machine learning-based analysis techniques. Also, the analysis techniques described herein avoid the costs associated with human judges and do not require training/re-training or inference optimization required by techniques that implement deep neural networks (DNNs). Another advantage is that because the analysis techniques described herein are based on statistical distributions they can be easily parallelized and accelerated. Moreover, the results (e.g., similarity measurements) of the analysis techniques, in at least some embodiments, are used to improve or modify the artificial agents, improve the system or environment implementing artificial agents, a combination thereof, or the like. For example, the analysis results are used to rank or score artificial agents, train or re-train artificial agents for improving the human-likeness of the agents' behavior, or to adjust an artificial agent's behavior in real-time while executing in an operating environment (e.g., a video game, a vehicle, a robot, etc.). Other applications include optimizing the curriculum in a curriculum-based learning paradigm, evaluating the design of a reward signal, optimizing neural architectures, and early termination of training an agent when sufficient similarity is reached. It should be understood that the two-sample hypothesis techniques described herein are also applicable to evaluating the behavior of multiple artificial agents to determine the similarity of the behaviors between the multiple artificial agents. The results of this analysis is used, for example, to increase the diversity in behaviors in a multi-agent setting.

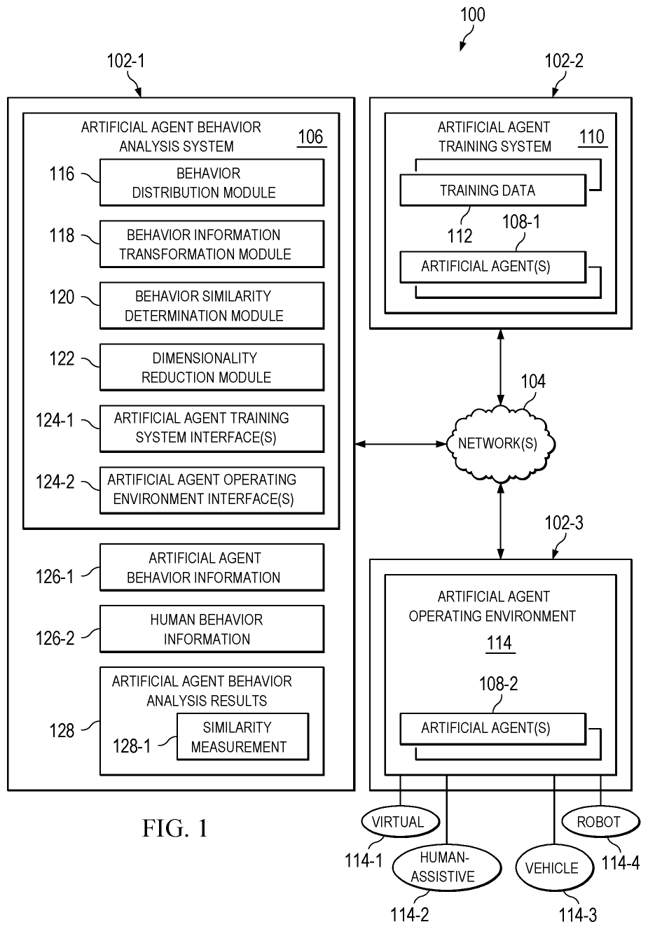

FIG. 1 illustrates an example operating environment 100 for evaluating the human-likeness of artificial agent behavior and modifying the artificial agents based on the evaluation. As shown in FIG. 1, the operating environment 100 comprises one or more information processing systems 102 (shown as systems 102-1 to 102-3) that are communicatively coupled by one or more networks 104. It should be understood that the number of information processing systems 102 shown in FIG. 1 is for illustration purposes only. For example, a single system 102 or a lesser/greater number of information processing systems 102 are able to include the components and perform the operations described herein. Examples of information processing systems 102 include servers, desktop computers, laptop/notebook computers, mobile devices, or various other types of computing systems or devices. The network(s) 104, in at least some embodiments, is implemented utilizing wired and or wireless networking mechanisms. For example, the network 104, in at least some embodiments, comprises wireless communication networks, non-cellular networks such as Wi-Fi networks, public networks such as the Internet, private networks, and so on. The wireless communication networks support any wireless communication standard and include one or more networks based on such standards.

In the example shown in FIG. 1, a first information processing system 102-1 comprises an artificial agent behavior analysis (AABA) system 106 that evaluates one or more behaviors of artificial agents 108 (shown as 108-1 and 108-2) and, in at least some embodiments, modifies the behavior of an artificial agent 108 based on this evaluation. Artificial agent behavior is an autonomous action(s) taken by an artificial agent 108 during operation/execution in response to its environment. Examples of artificial agent behaviors include autonomous driving behaviors (e.g., lane negotiation, collision avoidance, turning, etc.), autonomous navigation of a virtual gaming environment, autonomous fabrication a product, autonomous interaction with a human, prediction, perception, reasoning, and so on.

The artificial agents 108, in at least some embodiments, are implemented at the first information processing system 102-1, one or more other information processing systems 102, or a combination of both. For example, one or more agents 108 are implemented at a second information processing system 102-2 and a third information processing system 102-3. The second information processing system 102-2 comprises an artificial agent training system 110 that uses training data 112 to train artificial agents 108-1 for autonomously performing one or more actions/behaviors in response to their environment. In one example, the artificial agent training system 108 is a machine learning (ML)-based training system. However, different techniques, such as Navigation Mesh and behavior trees, can be used to program or train an artificial agent 108 as well. The third information processing system 102-3 comprises one or more artificial agents 108-2 executing within an operating environment 114, such as virtual environment (e.g., video game) 114-1 or a user-assistive environment 114-2 (e.g., virtual chat). In another example, the operating environment 114 is an entity, such as a vehicle 114-3 (manned or unmanned) or a robot 114-4, implementing the artificial agents 108-2. It should be understood the first and second information processing systems 102-2, 102-3 are only provided as examples of the types of systems on which artificial agents 108 can be implemented. The AABA system 106 of the first information processing system 102-1 is able to analyze/evaluate different types of behaviors performed by different types of artificial agents across various domains and systems.

Although FIG. 1 shows the AABA system 106 implemented at the first information processing system 102-1, in other embodiments, the AABA system 106 is implemented as part of, or in conjunction with, the artificial agent training system 110, the artificial agent operating environment 114, another system/environment capable of implementing artificial agents 108, a combination thereof, or the like. In at least some embodiments, the AABA system 106, includes a behavior distribution module 116, a behavior information transformation module 118, a behavior similarity determination module 120, and a dimensionality reduction module 122. One or more of these modules, in at least some embodiments, are distributed across multiple information processing systems, and two or more of these modules can be combined. In at least some embodiments, the AABA system 106 includes one or more interfaces 124, such as an artificial agent training system interface 124-1 and an artificial agent operating environment interface 124-2. The AABA system 106 uses the interfaces 124, for example, to interface and communicate with one or more systems comprising artificial behavior information 126, such as artificial agent behavior information 126-1 and human behavior information 126-2, or that apply the results 128 of the artificial agent behavior analysis performed by the AABA system 106.

As described in greater detail below, the AABA system 106 uses one or more of the behavior distribution module 116, the behavior information transformation module 118, the behavior similarity determination module 120, or the dimensionality reduction module 122 to perform an artificial agent behavior analysis that quantitively evaluates the similarity of the behaviors exhibited by artificial agents 108 to those exhibited by human counterparts (e.g., human users) in a domain-agnostic manner. The behavior analysis is a statistical method that uses a distribution of an agent's state-action pairs (e.g., a trajectory) to determine if the behavior of the agent is human-like and further quantifies how human-like the behavior is. For example, the AABA system 106 analyzes the human-like behavior (HLB of an artificial agent 108 based on comparing the distribution of the behavior between a distribution of a human behavior sequence and a distribution of an artificial intelligence behavior sequence associated with the same or similar task/goal. Based on the behavior analysis, the AABA system 106 generates behavior analysis results 128 that include, for example, a measure of similarity 128-1 (also referred to herein as a similarity measurement 128-1) for each evaluated artificial agent 108. The measure of similarity (human-likeness) 128-1 quantifies/measures how similar the behavior of the artificial agent 108 is to the behavior of a human(s) counterpart. For example, if the behavior being evaluated is navigating an environment of a video game to achieve a goal (e.g., reach an endpoint), the measure of similarity 128-1 quantifies the human-likeness of the artificial agent's movements in achieving this goal. In another example, the measure of similarity 128-1 quantifies the performance (in terms of human-like behavior) of a robot with respect to behaviors such as moving or performing a task. In a further example, the measure of similarity 128-1 quantifies how believable a human-assistive software agent or a non-playable character is when interacting with a human.

In at least some embodiments, the behavior analysis results 128 are applied by one or more systems to, for example, improve or enhance one or more artificial agents 108, improve or enhance the system or environment implementing the artificial agent(s) 108, a combination thereof, or the like. For example, the AABA system 106 or another system, such as the artificial agent training system 110 or the artificial agent operating environment 114, uses the measure of similarity 128-1 to rank or score the artificial agents 108 that have been evaluated, to train or re-train artificial agents 108 for improving the human-likeness of the agents' behavior, or to adjust an artificial agent's behavior in real-time while executing in an operating environment 114 (e.g., a video game, a vehicle, a robot, etc.). Other applications include optimizing the curriculum in a curriculum-based learning paradigm, evaluating the design of a reward signal, optimizing neural architectures, and early termination of training an agent when sufficient similarity is reached.

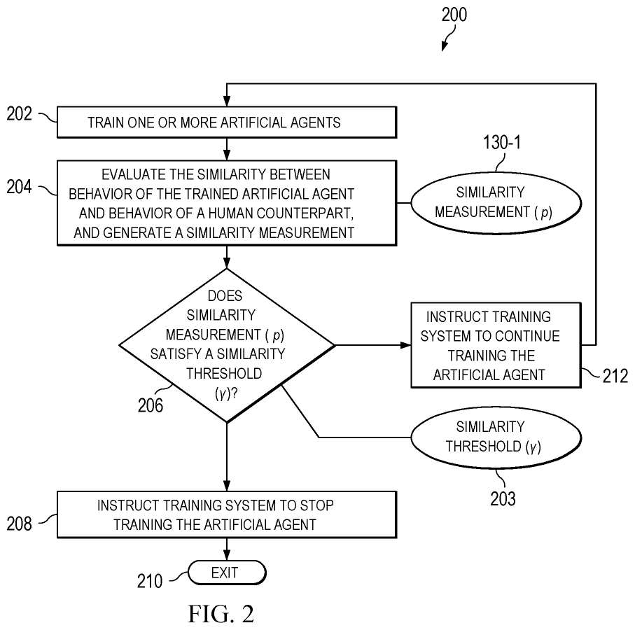

For example, FIG. 2 illustrates in flow chart form, an overview of one example method 200 of applying the behavior analysis results 128 as part of an artificial agent training process. In this example, p is the similarity measurement 128-1 and γ is a predefined confidence level 201. At block 202, the training system 110 trains an artificial agent 108 (e.g., an AI/ML agent) using one or more training techniques, such as reinforcement learning (RL). During training, agent behavior information 126-1 associated with the artificial agent 108 is generated for one or more tasks (e.g., navigating an environment within a video game). At block 204, the AABA system 106 analyzes the agent behavior information 126-1 with respect to human behavior information 126-2 associated with the same task. Human behavior information 126-2, in at least some embodiments, includes behavior of an actual human counterpart or behavior of an artificial agent 108 controlled by a human counterpart. Based on this analysis, the AABA system 106 generates a similarity measurement (p) 128-1 quantifying the human-likeness of the artificial agent's behavior 126-1. At block 206, the AABA system 106 (or the training system 110) determines if the similarity measurement p 128-1 satisfies a similarity threshold (γ) 201 (e.g., p≥γ). If so, at block 210, the AABA system 106 instructs the training system 110 to stop training the AABA system 106, which reduces training computational time and prevents overtraining of the artificial agent 108. The process then exits at block 210. The trained artificial agent(s) 108 is then implemented in one or more operating environments 114. Otherwise, at block 212 the AABA system 106 instructs the training system 110 to adjust the behavior of the artificial agent 108 by continuing the training the artificial agent 108, and the process returns to block 202. In other embodiments, the training system 110 receives the similarity measurement p 128-1 and performs the operations at block 206 rather than the AABA system 106.

In at least some embodiments, one or more of the techniques implemented by the AABA system 106 for evaluating artificial agent behavior are based on, for example, deep reinforcement learning and distribution analysis and comparison. Deep reinforcement learning is one technique for training/programming artificial agents 108 by a system, such as the training system 110 of FIG. 1. In one example, the standard formulation of reinforcement learning (RL) is a Markov decision process (MDP) in which an artificial agent 108 interacts with an environment ε according to a policy with the goal of maximizing its cumulative expected reward. Let π_{θ}(a|s) denote the decision policy of a given artificial agent 108, where π_{θ} models the conditional distribution over action a given state s and is parameterized by θ. In deep reinforcement learning (DRL), this conditional distribution is modeled using a deep neural network (DNN). The space of all actions and states can be denoted as [symbol] and [symbol] , respectively, such that a∈ [symbol] and s∈ [symbol] . At each time step t, the artificial agent 108 observes the current state st and samples an action aₜ according to π_{θ}. The environment ε then responds with a scalar reward rₜ that reflects the value of that transition and a new state sₜ₊₁, which is sampled from the transition dynamics of ε denoted by p_{ε}(sₜ₊₁|s, a). Note that, given state s and action a, the transition dynamics satisfy the Markov property such that the probability distribution over the next state is conditionally independent of all previous states and actions. The objective under this paradigm is to learn the optimal parameters θ* that maximize the expected return, as given by EQ 1:

[symbol]

(θ)= [symbol] _{r˜p}_{_{θ}}_{(τ)}[Σₜ₌₀^{T}γ^{t}rₜ] where p_{θ}(τ)=p(s₀)Πₜ₌₀^{T-1}P_{ε}(sₜ₊₁|sₜ,aₜ)π_{θ}(aₜ|sₜ) (EQ 1).

Here, p_{θ}(τ) denotes the distribution over all possible trajectories τ when following policy π_{θ}, and p(s₀) denotes the initial state distribution. A sequence of state-action pairs spanning an initial state so to a terminal state s_{N} is defined as an episode, and a continuous subsequence of an episode over a horizon of T≤N time steps is defined as a trajectory, which is denoted τ. In other words, each trajectory τ is defined by a sequence of state-action pairs over a horizon of T time steps such that τ=(s₀, a₀, s₁, . . . , a_{T-1}, s_{τ}). Note that Σₜ₌₀^{T}γ^{t}rₜ represents the total return of trajectory τ over this time horizon where γ∈[0,1] is a discount factor used to ensure a finite return. It should be understood that other techniques can be used to train/program the artificial agents 108.

One example of a distribution analysis and comparison technique implemented by the AABA system 106 is Maximum Mean Discrepancy (MMD). MMD is a class of kernel-based divergence metrics used to compute the distance between the projections of two high-dimensional data distributions. MMD distance is defined as:

MMDₖ[x,y]= [symbol] _{X,X}[k(x,x′)]+ [symbol] _{Y,Y}[k(y,y′)]−2 [symbol] _{X,Y}[k(x,y)] (EQ 2).

The AABA system 106 empirically estimates this distance by independently drawing n samples from each distribution. Given that kernel k maps to a reproducing kernel Hilbert space, then the MMD distance given by EQ 2 is zero if and only if the distributions X and Y are identical. Here, x and y denote sample distributions of n elements independently drawn from X and Y, respectively, where x′ indicates that the sample has been shuffled and [symbol] _{X,Y} [k(x, y)] is estimated either pairwise or elementwise. Estimating [symbol] _{X,Y} [k(x, y)] with pairwise distances such that

$${𝔼}_{X , Y} [ k ( x , y ) ] = \frac{1}{{n}^{2}} {\sum }_{i = 1}^{n} {\sum }_{j = 1}^{n} k ( {x}_{i} , {y}_{j} )$$

uses each sample point to maximum effect. However, the compute cost increases quadratically with the size of the sample distribution. As such, with larger volumes of data, [symbol] _{X,Y}[k(x, y)] can be estimated element-wise such that

$${𝔼}_{X , Y} [ k ( x , y ) ] = \frac{1}{n} {\sum }_{i = 1}^{n} k ( {x}_{i} , {y}_{i} ) ,$$

which is intuitively less computationally expensive but more prone to sampling error as the result is dependent on the sampling order. Therefore, in at least some embodiments, the AABA system 106 uses the pairwise estimation of [symbol] _{X,Y} [k(x, y)] with the standard Gaussian kernel and the Euclidean distance function such that k(x, y)=−exp(∥x−y∥²)/2σ². Here, σ is referred to as the kernel bandwidth and is set to the median pairwise distance of the aggregated samples from X and Y. It should be understood that MMD is only one example of a distribution analysis and comparison technique implemented by the AABA system 106 and other techniques are applicable as well, such as Wasserstein Distances or Sinkhorn Divergences.

As described below, the AABA system 106 also implements one or more non-parametric statistical hypothesis testing techniques for evaluating artificial agent behavior. Statistical inference is the process of drawing conclusions about a population parameter or population distribution from sample distributions. Unlike parametric statistical inference, which estimates sample statistics to model a population distribution using assumptions about the data, non-parametric statistical inference analyzes the sample distribution directly. Among this class of tests and tools, sampling methods such as bootstrap resampling and permutation testing offer increased performance and generality over traditional methods without requiring distributional assumptions. With bootstrap resampling, the AABA system 106 repeatedly draws samples of size m with replacement from a sample distribution of size n to recompute a sample statistic. Although some bootstrap resampling methods set m=n, m out of n bootstrapping (i.e., m≤n) can yield more consistent results. Similar to bootstrap resampling, permutation tests do not require a priori knowledge of the data distribution. However, unlike bootstrap resampling, this class of tests resamples from the sample distribution without replacement. In at least some embodiments, the AABA system 106 implements one or more of bootstrap resampling techniques or permutation testing techniques for hypothesis testing, although other techniques are applicable as well.

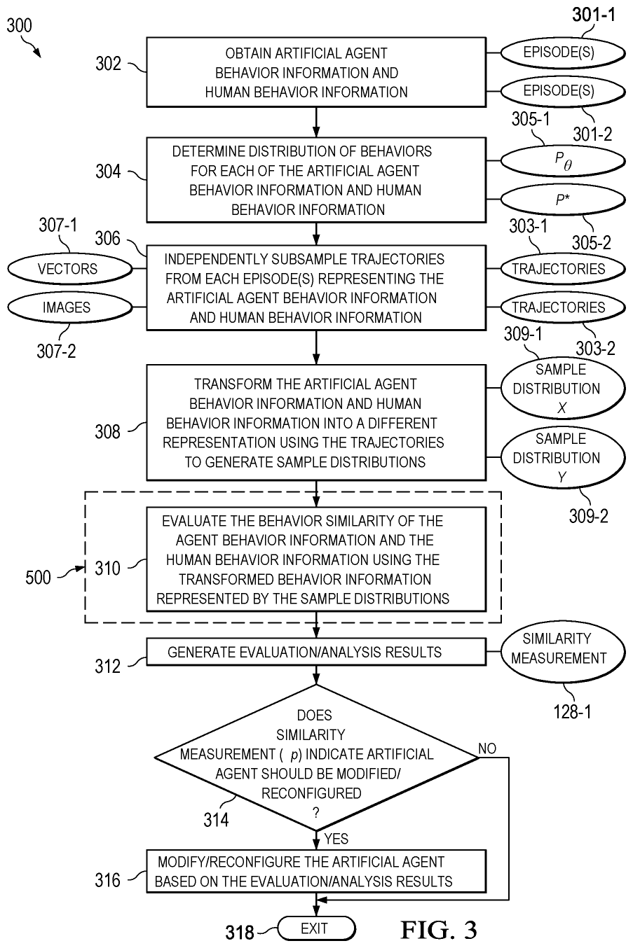

FIG. 3 illustrates, in flow chart form, an example method 300 for evaluating artificial agent behavior. Although subprocesses of method 300 are illustrated and described in an example order, the method 300 is not limited to this particular order, and in some embodiments, certain processes may be performed in a different order, or concurrently rather than in sequential order, or may be omitted altogether. Moreover, although the method 300 is described in the example context of a video game environment and movement/navigation behaviors, it should be understood the techniques described herein are not limited to such an environment and behaviors.

As described below, the method 300 analyzes the similarity between artificial agent behavior and human counterpart behavior (or another artificial agent) using a non-parametric two-sample hypothesis testing technique, which is configured according to a behavior similarity hypothesis. In at least some embodiments, the behavior similarity hypothesis indicates that the behaviors of any two agents are sufficiently similar if the distributions over their respective behaviors, which are representable as episodes/trajectories, are sufficiently similar. Also, the method 300 is described in an example context where the artificial agents 108 implement a pre-trained decision policy π_{θ} that drives the artificial agents 108 to complete a given task when deployed in an environment Σ, such as a video game environment. Similarly, the human counterpart(s) being compared to the artificial agents 108 in the method 300 independently completes the same task in the same environment Σ. For example, if the artificial agent 108 is an NPC in a video game environment, the human counterpart is independently given control over the same (or different) artificial agent(s) 108 to complete the same task in the same environment Σ. As such, in at least some embodiments, both the artificial agent 108 and the human counterpart are bound to the same initial state distribution p(s₀) with the same transition dynamics p_{ε}(sₜ₊₁|sₜ, aₜ). The distribution of the behaviors/trajectories induced by decision policy π_{θ} of the artificial agent 108 is defined as P_{θ}(τ) and the distribution of behaviors/trajectories induced by the human counterpart is defined as P*(τ). For brevity, these distributions are herein referred to as P_{θ} and P*, respectively.

At block 302, the AABA system 106 takes as input agent behavior information 126-1 for one or more artificial agents 108 and takes as input human behavior information 126-2 for one or more human counterparts. The behavior information 126, in at least some embodiments, is stored locally at the information processing system comprising the AABA system 106. In other embodiments, the behavior information 126 is stored remote from the information processing system comprising the AABA system 106. The behavior information 126, in at least some embodiments, is obtained from the artificial agent training system 110, the operating environment 114, human testers, human players, a combination thereof, or the like. For illustrative purposes, the behavior information 126 in this example represents navigation/movement behaviors of the artificial agent(s) 108 and human counterpart(s) within a three-dimensional (3D) space of a video game environment. Therefore, in this example, each movement identified by the behavior information 126 is defined by an x-coordinate, a y-coordinate, and a z-coordinate. It should be understood that other types of behavior are representable/definable by different characteristics or attributes.

Also, the agent behavior information 126-1 and the human behavior information 126-2 are each represented by one or more episodes 301 (illustrated as episode 301-1 and episode 301-2). For example, if the behavior being evaluated is navigation within a virtual environment, such as a video game, the agent behavior information 126-1 and the human behavior information 126-2 each comprise one or more episodes 301 representing all the navigation movements of the artificial agent 108 and the human counterpart, respectively, for a given task. It should be understood that the behavior of an artificial agent 108 and a human counterpart is not limited to being represented as by an episode(s) and trajectories, as other techniques are applicable as well. Each episode 301-1 of the artificial agent behavior information 126-1 is comprised of trajectories τ 303-1 and each episode 301-2 of the human behavior information 126-1 is composed of trajectories τ 303-2. As described above, a trajectory τ 303 is a continuous subsequence of an episode 301 over a horizon of T≤N time steps. In other words, each trajectory τ 303 is defined by a sequence of state-action pairs over a horizon of T time steps such that τ=(s₀, a₀, s₁, . . . , a_{T-1}, s_{τ}). Therefore, a trajectory τ 303 is a slice/window of the episode comprising a subsequence of the behavior/actions performed the artificial agent 108 or human counterpart. For example, if an episode 301 represents 1000 movements taken by the artificial agent 108, each trajectory τ 303 represents a subset of these 1000 movements.

At block 304, the distribution module 116 of the AABA system 106 determines/generates distributions P 303 for the artificial agent behavior information 126-1 and the human behavior input 126-2. For example, the distribution generation module 116 generates a distribution P_{θ} 303-1 for the artificial agent behavior information 126-1 and generates a distribution P* 303-2 for the human behavior information 126-2. In this example, the distributions P 305 are over the space of trajectories 303, e.g., P_{θ}(τ) 301-1 and P*(τ) 301-2 determined at block 304.

At blocks 306 and 308 distribution module 116 and the behavior information transformation module 118 (referred to herein as transformation module 118 for brevity) of the AABA system 106 operate to generate a sample distribution X 309-1 for the artificial agent behavior information 126-1 and a sample distribution Y 309-2 for the human agent behavior information 126-2. Sample distribution X 309-1 and sample distribution Y 309-2 are independently drawn from distribution P_{θ} 305-1 and distribution P* 305-2, respectively. For example, at block 306, let E denote a set of M episodes 301 independently collected from each of the artificial agent behavior information 126-1 and the human behavior information 126-2. Let N denote the total number of time steps between the initial state so and the terminal state s_{N} in a given episode. The distribution module 116 independently subsamples K trajectories 303 of length T from each episode 301 with replacement. In some instances, the length of an episode 301 can be heavily skewed. Therefore, to correct for any biases from larger episodes with more time steps, K is set to the length of the largest episode 301 in the given set. As such, the size of each sample distribution 309 (e.g., |X|, |Y|) generated at block 308, in at least some embodiments, is M·K. This ensures that a trajectory drawn at random from the aggregated sample distribution has a uniform probability of being from any of the episodes 301 collected. Also, there is no point-to-point correspondence between sample distribution X 309-1 and sample distribution X 309-2.

At block 308, the transformation module 118 transforms the behavior information 126-1 of the artificial agent(s) 108 and the behavior information 126-2 of the human counterpart(s) from a first representation to a different representation, such as vectors 307-1 and images 307-2). In at least some embodiments, this different representation is a high-dimensional representation of the behavior information 126, such as a vector 307-1, an image 307-2, or the like. In one example, the transformation module 118 receives as input each sampled trajectory τ 303 generated by the distribution module 116 at block 306. Then, for each sampled trajectory τ 303, the transformation module 118 represents the sampled trajectory τ 303 as a vector 307-1 including the absolute three-dimensional (3D) location of the artificial agent 108 at each time step. The transformation module 118 uses the vector 307-1 to transform and visualize the sampled trajectory 303 into a two-dimensional (2D) rendering (image) 307-2. The absolute 3D location of the artificial agent 108 can represent the minimal representation of the artificial agent's response to a given state. In this example, let cₜ be the 3D Cartesian coordinates of an artificial agent 108 at time t and let c(τ) be the sequence of coordinates for a given sampled trajectory 303 such that c(τ)={c₀, . . . , c_{T}} and cₜ=(xₜ, yₜ, zₜ). The transformation module 118 projects a sampled trajectory τ 303 into a 2D rendering by using c(τ) to view the navigation of the artificial agent 108 from the z-axis and applying a min-max scaling over the (x, y) coordinates to project each vector of Cartesian coordinates into the range of [0, 1]. The transformed coordinates (\hat{x},ŷ) are defined as

$$\hat{x} = \frac{x - {x}_{min}}{{x}_{max - {x}_{min}}} and \hat{y} = \frac{y - {y}_{min}}{{y}_{max - {y}_{min}}} ,$$

respectively. Note that the minimum and maximum of each x and y coordinate space are determined over c(τ), which is the sequence of coordinates of the sampled trajectory τ 303. The transformation module 118 scales these coordinates using the desired Height×Width (H×W) resolution as shown in EQ 3:

$${I}_{τ} ( H \cdot \hat{x} , W \cdot \hat{y} ) = \{ \begin{matrix}1 & ∀ \hat{x} , \hat{y} ∈ c ( τ ) \\ 0 & otherwise\end{matrix} . \qquad ( EQ 3 )$$

The resulting H×W image 307-2 is referred to as the top-down projection 307-2 of the sampled trajectory τ 303, which is denoted as operator I_{τ}.

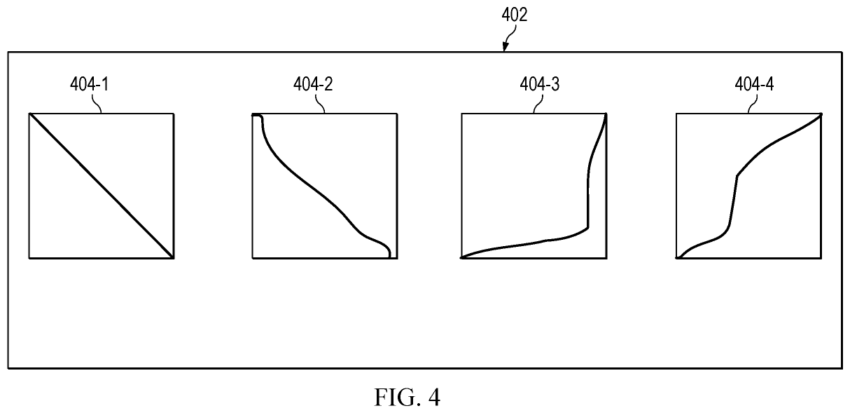

As objectives become increasingly complex, the episodes 301 can vary greatly and non-uniformly, thereby introducing artifacts. For example, the fine details of long, complex trajectories lose their salience in the projections, and the continuity of short smooth trajectories is disrupted, which introduces a sparse projection. Therefore, in at least some embodiments, the transformation module 118 introduces two modifications to the top-down trajectory projection process described above. In the first modification, the transformation module 118 exploits the conditional independence property of MDPs to subsample fixed-length trajectories 303 without replacement from each episode 301 using a finite time horizon denoted by T. In the second modification, the transformation module 118 linearly interpolates along c(τ) and dynamically shifts and scales the axes to increase the fidelity of the resulting image 307-2. FIG. 4 shows various examples of projection output 402 generated by the transformation module 118. In this example, the projection output 402 comprises one or more projections/images 404 (illustrated as projections 404-1 to 404-4) representing navigation behavior of one or more artificial agents 108 and one or more human counterparts. In at least some embodiments, each sampled trajectory τ 303 determined for the behavior information 126 is represented as a projection/image 307-2. In at least some embodiments, the output of the transformation module 118 is a sample distribution X 309-1 (of distribution P_{θ} 305-1) comprising the collection of projections/images 307-2 generated for the artificial agent behavior information 126-1 and a sample distribution Y 309-2 (of distribution P* 305-2) comprising the collection of projections/images 307-2 generated for the human behavior information 126-2.

Referring to block 308 of FIG. 3, in another example, the transformation module 118 transforms the behavior information 126 into a different representation by vectorizing the sampled trajectories τ 303 representing the artificial agent behavior information 126-1 and the human behavior information 126-2 using the absolute 3D location of the artificial agent 108 at each time step, similar to the example described above. However, in this example, the transformation module 118 does not transform the vectors 307-1 representing the trajectories τ 303 into a 2D visual representation. Instead, the transformation module 118 generates the sample distribution X 309-1 and the sample distribution Y 309-2 directly from the vectors 307-1 representing the sampled trajectories τ 302, which comprise x, y, and z coordinate data of the sampled trajectories τ 303. For example, the transformation module 118 transforms each episode 301-1 and 301-2 representing the artificial agent behavior information 126-1 and the human behavior information 126-2, respectively, into a distribution of movements by subsampling fixed-length trajectories τ 303 uniformly with replacement from each episode 301 using a finite time horizon denoted by T. More formally, let cₜ be the 3D Cartesian coordinates of an artificial agent 108 at time t and let c(τ) be the sequence of coordinates for a given trajectory τ 303 such that c(τ)={c₀, . . . , c_{T}} and cₜ=(xₜ, yₜ, zₜ). Given an episode of length N, the transformation module 118 considers overlapping trajectories to be uniquely different such that c(τᵢ) and c(τⱼ) have the same probability

$$\frac{1}{N - T}$$

of being sampled, where τᵢ={s₀, . . . , s_{T}}, τⱼ={s₁, . . . , s_{T+1}}, and T<N. The transformation module 118 ensures that the AABA system 106 analyzes behavior (e.g., navigation/movement) without being biased by absolute location, by subtracting the initial Cartesian coordinate c₀ from each sample c(τ) so that each movement starts from the origin. As such, the output generated by the transformation module 118 is a sample distribution X 309-1 comprising the collection of vectors 307-1 generated for the artificial agent behavior information 126-1 and the sample distribution Y 309-2 comprising the collection of vectors 307-1 generated for the human behavior information 126-2.

At 310 the behavior similarity determination module 120 of the AABA system 106 evaluates the behavior similarity of the agent behavior information 126-1 and the human behavior information 126-2 using the transformed behavior information represented by sample distribution X 309-1 and sample distribution Y 309-2 outputted by the transformation module 118. As described above, the behavior similarity determination module 120 is configured based on a central hypothesis indicating that the similarity between the behavior of an artificial agent to that of a human counterpart is defined by the similarity between their respective distributions of trajectories 303. In at least some embodiments, the behavior similarity determination module 120 takes as input the sample distribution X 309-1 and the sample distribution Y 309-2, which were independently drawn from distributions P_{θ} 305-1 and P* 305-2, respectively. As described above, P_{θ} 305-1 denotes the distribution of trajectories τ 303-1 induced by an artificial agent 108 following a decision policy π_{θ}, while P* 305-2 denotes the distribution of trajectories τ 303-2 induced by a human counterpart. In at least some embodiments, the behavior similarity determination module 120, for the purpose of evaluating the behavior similarity between P* 305-1 and P_{θ} 305-1, is configured to evaluate the null hypothesis (H₀) that these distributions are equal against the alternative hypothesis (H₁) that they are different, as summarized below:

H₀:P*=P_{θ}

H₁:P*≠P_{θ}.

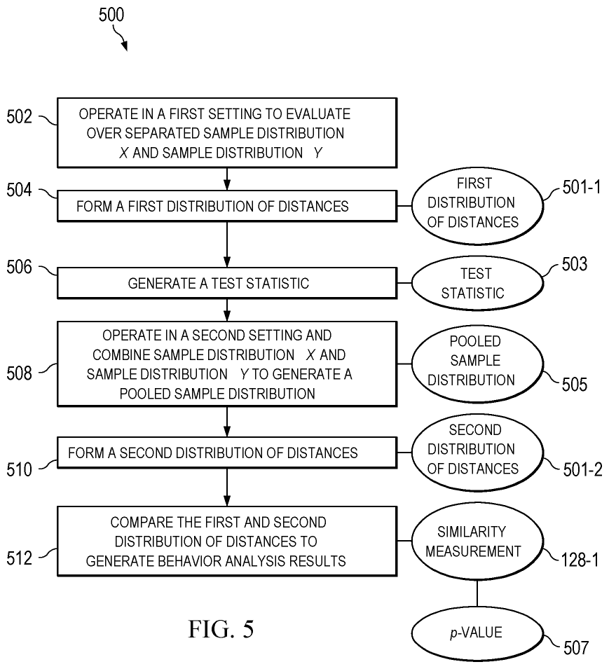

In at least some embodiments, the behavior similarity determination module 120 performs a two-sample hypothesis testing technique to evaluate the behavior 126 of the artificial agent(s) 108 and human counterpart(s). FIG. 5 illustrates, in flow chart form, an example method 500 for performing the two-sample hypothesis testing technique. The example method 500 is performed at block 310 of FIG. 3. The two-sample hypothesis testing technique, in at least some embodiments, is motivated by the following insight: if the null hypothesis is true, then any difference between P* 305-1 and P_{θ} 305-2 should be due to sampling error. As such, the behavior similarity determination module 120 implements one or more techniques to calculate a test statistic 503 for the purpose of evaluating the difference between sample distribution X 309-1 and sample distribution Y 309-2. Examples of these techniques include the MMD and m out of n bootstrap resampling techniques described above. The behavior similarity determination module 120 then evaluates and compares this distribution of distances (e.g., MMD) in two settings, separated and pooled sample distributions, to generate behavior analysis results 128 including a similarity measurement 128-1, such as a p-value 507.

For example, at block 502, the behavior similarity determination module 120 operates in the first setting to evaluate over separated sample distribution X 309-1 and sample distribution Y 309-2. At block 504, given that xᵢ and yᵢ each denote subsamples of size m that are independently drawn with replacement from sample distribution X 309-1 and sample distribution Y 309-2, respectively, the behavior similarity determination module 120 forms a first distribution of MMD distances 501-1 by repeatedly recomputing MMDₖ[xᵢ, yᵢ] over S iterations where i∈{1, . . . , S}. This first distribution of distances 501-1 is denoted as δ_{X,Y}. At block 506, the behavior similarity determination module 120 calculates the test statistic 503, which is denoted as δ, according to EQ 4:

δ=quantile(δ_{X,Y},α) where α∈(0,1) EQ 4,

where quantile(δ_{X,Y},α) returns the α-th quantile over the distribution δ_{X,Y} and α is a hyperparameter designed to control the sensitivity of the test, as described below. It should be understood that other techniques for generating the test statistic 503 are applicable as well. For example, confidence intervals can used to generate the test statistic 503. In this example, given δ_{X,Y}, the mean and standard deviation is calculated so that the lower bound of a confidence interval defined by α is used to generate the test statistic 503.

At block 508, the behavior similarity determination module 120 operates in the second setting and combines sample distribution X 309-1 and sample distribution Y 309-2 to create a pooled sample distribution 505 denoted as Z. At block 510, the behavior similarity determination module 120 performs an evaluation operation by forming a second distribution of MMD distances 501-2. The similarity determination module 120 forms the second distribution of MMD distances 501-2 by repeatedly recomputing MMDₖ[xᵢ,yᵢ] over another S independently drawn samples where i∈{1, . . . , S}. However, in this second setting, xᵢ and yᵢ are both independently sampled from pooled distribution Z with replacement. This second distribution of distances 501-2 is denoted as δ_{Z}. At block 512, the behavior similarity determination module 120 compares the distribution of distances 501 from the two settings to generate behavior analysis results 128 including a similarity measurement 128-1 quantifying how similar the artificial agent's behavior 126-1 is to the human counterpart's behavior 126-2. In at least some embodiments, similarity measurement 128-1 is represented by a p-value 507. The similarity determination module 120, in at least some embodiments, generates the p-value 507 as the percentage of estimates δ_{Z} greater than the test statistic δ, as shown below in EQ 5, to evaluate the null hypothesis H₀:

$$p = \frac{\# ( {δ}_{Z} > δ )}{N} . \qquad ( EQ 5 )$$

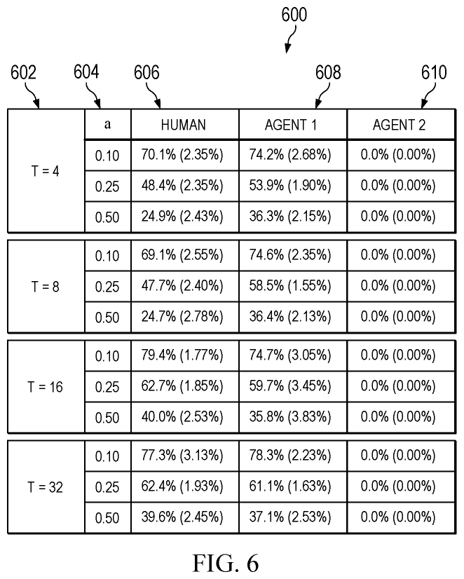

Referring to FIG. 3, at block 312 the behavior similarity determination module 120 generates artificial agent behavior analysis results 128 including the similarity measurement 128-1 (e.g., p-value 507). FIG. 6 illustrates one example of the artificial agent behavior analysis results 128 in table 600 form. In this example, the “T” column 602 represents the time horizon used in the evaluation, the “a” column 604 represents the quantile over baseline distribution. The “Human” column 606 represents the similarity measure between the behavior of two human counterparts. The “Agent 1” column 608 represents the similarity measure of a first artificial agent and the combined behavior of multiple human counterparts. The “Agent 2” column 610 represents the similarity measure of the behavior of a second artificial agent and the combined behavior of multiple human counterparts. Agent 1 and Agent 2, in this example, are trained/programmed. The percentages in the parentheses are the interquartile range (IQR) showing the degree of variance for the similarity measurements whereas the percentages outside of the parentheses are the medians over a given number of runs.

Referring to FIG. 3, at block 314, the AABA system 106 determines if the similarity measurement 128-1 indicates that the artificial agent 108 should be modified/reconfigured. For example, the AABA system 106 determines if the similarity measurement 128-1 indicates that the human-likeness of the artificial agent's behavior fails to satisfy a similarity threshold. If so, the process then exits at block 318 or, alternatively, returns to block 302. Otherwise, at block 316, the AABA system 106 modifies or reconfigures/programs the artificial agent 108 as described above with respect to FIG. 1 and FIG. 2. For example, the artificial agent 108 is modified such that the human-likeness of the artificial agent's behavior is improved. Alternatively, the AABA system 106 instructs another system, such as the training system 110, to perform the modification or reconfiguration of the artificial agent 108. The process then exits at block 318 or, alternatively, returns to block 302.

As described above, the p-value 507, in at least some embodiments, is used by the AABA system 106 as a similarity measure 128-1. In these embodiments, given that P* and P_{θ} are the same distribution under the null hypothesis (H₀), then the first distribution of MMD distances 501-1 as computed over the separated sample distribution X 307-1 and the sample distribution Y 307-2 should be the same as the second distribution of MMD distances 501-2 as computed over the pooled sample distribution Z 505. Thus, when P*=P_{θ}, it follows that the resulting p-value 507 converges towards 1−α as S→∞. Furthermore, when P*≠P_{θ}, the AABA system 106 interprets the derived p-value 507 as a measure of closeness between distributions P* and P_{θ}. To demonstrate this, consider a series of experiments using a toy example where P* is distributed as a 128-dimensional standard Gaussian with zero mean and unit variance, which is denoted as [symbol] (0,1). For each experiment, S=1000 iterations are run using subsample size m=100. Due to the inherent stochasticity of the two-sample hypothesis testing technique performed by the behavior similarity determination module 120, each experiment is repeated 10 times and both the median p-value and the observed interquartile range (IQR) are reported.

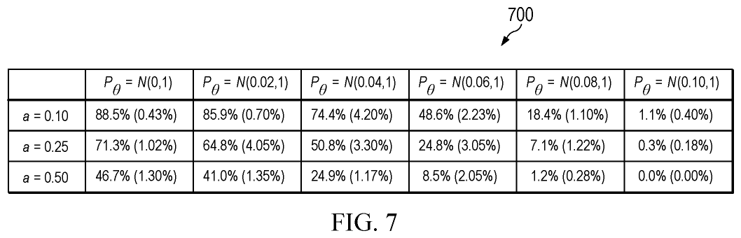

First, the case where P_{θ}=P*= [symbol] (0,1) using α=0.10 is considered. A median p-value of 88.5% with an IQR of 0.43% is observed. Next, to demonstrate how the p-value resulting from the two-sample hypothesis test performed by the behavior similarity determination module 120 is used as a measure of similarity between distribution P_{θ} 305-1 and distribution P* 305-2, it is shown that p monotonically decreases as the distribution P_{θ} 305-1 is incrementally shifted by epsilon ϵ=0.02. Each P_{θ}= [symbol] (ϵ,1) to P*= [symbol] (0,1) is compared and the observed results are shown in the table 700 of FIG. 7. Furthermore, the distribution of the MMD distances 501 shifts with P_{θ} 305-1. Note that when P_{θ}= [symbol] (0.10,1), the distributions of δ_{X,Y} and δ_{Z} are nearly separated. In at least some embodiments, the AABA system 106 controls the sensitivity of the two-sample hypothesis test by adjusting α. Intuitively, higher values of α yield a larger test statistic δ and, therefore, increase the sensitivity of the two-sample hypothesis test performed by the behavior similarity determination module 120. As shown in the table 700 of FIG. 7, a more sensitive test yields lower p-values as the distributions diverge. Therefore, in cases where the behavior of multiple artificial agents 108 are being compared against the behavior of a human counterpart, a is adjustable to control for sensitivity and create a more informative comparison.

While the computational cost of estimating the MMD distance between two samples increases quadratically with the size of each sample, it also increases linearly with the dimensionality of the data. Therefore, in at least some embodiments, the dimensionality reduction module 122 of the AABA system 106 implements one or more dimensionality reduction techniques to reduce such computational costs by removing redundancies in high-dimensional data (e.g., images) and reducing the number of random variables under consideration (e.g., pixels) all while preserving the information needed to understand the original distribution. One example of a dimensionality reduction techniques is principal component analysis (PCA). To demonstrate the effects of PCA on the two-sample hypothesis test performed by the behavior similarity determination module 120, consider a sample distribution D comprised of 22,600 fixed-length trajectories subsampled from 100 different episodes observed from 4 human counterparts. In this example, the dimensionality reduction module 122 linearly projects high-dimensional (HD) data into a low-dimensional (LD) space such that P₁₂₈: [symbol] ²¹¹⁶→ [symbol] ¹²⁸ where D^{HD}∈ [symbol] ²¹¹⁶, D^{LD}∈ [symbol] ¹²⁸, and P₁₂₈ is the top 128 principal components which explain nearly 75% of variance in the data. In this example, reducing the dimensionality of the data significantly minimizes the impact of sample size on computational cost while maintaining the stability of the two-sample hypothesis test performed by the behavior similarity determination module 120. It should be understood that other dimensionality techniques are applicable as well.

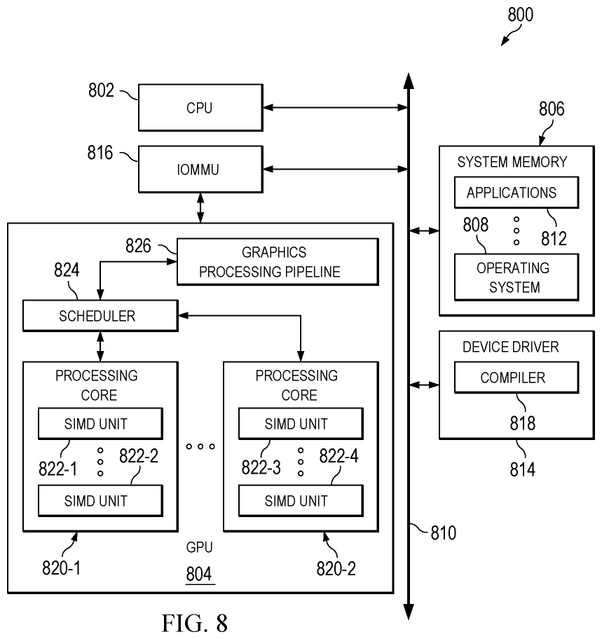

The techniques described herein are, in different embodiments, employed at any of a variety of processors or parallel processors (e.g., vector processors, graphics processing units (GPUs), general-purpose GPUs (GPGPUs), non-scalar processors, highly parallel processors, artificial intelligence (AI) processors, inference engines, machine learning processors, other multithreaded processing units, and the like). Referring now to FIG. 8, a block diagram of a processing system 800, such as systems 102-1 to 102-3 is illustrated in accordance with some embodiments, configured with parallel processors. The processing system 800 includes a central processing unit (CPU) 802 and a graphics processing unit (GPU) 804. In at least some embodiment, the CPU 802, the GPU 804, or both the CPU 802 and GPU 804 are configured to implement the AABA system 106. The CPU 802, in at least some embodiments, includes one or more single- or multi-core CPUs. In various embodiments, the GPU 804 includes any cooperating collection of hardware and or software that perform functions and computations associated with accelerating graphics processing tasks, data-parallel tasks, nested data-parallel tasks in an accelerated manner with respect to resources such as conventional CPUs, conventional graphics processing units (GPUs), and combinations thereof.

In the embodiment of FIG. 8, the CPU 802 and the GPU 804 are formed and combined on a single silicon die or package to provide a unified programming and execution environment. This environment enables the GPU 804 to be used as fluidly as the CPU 802 for some programming tasks. In other embodiments, the CPU 802 and the GPU 804 are formed separately and mounted on the same or different substrates. It should be appreciated that processing system 800, in at least some embodiments, includes more or fewer components than illustrated in FIG. 8. For example, the processing system 800, in at least some embodiments, additionally includes one or more input interfaces, non-volatile storage, one or more output interfaces, network interfaces, and one or more displays or display interfaces.

As illustrated in FIG. 8, the processing system 800 also includes a system memory 806, an operating system 808, a communications infrastructure 810, and one or more applications 812. Access to system memory 806 is managed by a memory controller (not shown) coupled to system memory 806. For example, requests from the CPU 802 or other devices for reading from or for writing to system memory 806 are managed by the memory controller. In some embodiments, the one or more applications 812 include various programs or commands to perform computations that are also executed at the CPU 802. The CPU 802 sends selected commands for processing at the GPU 804. The operating system 808 and the communications infrastructure 1010 are discussed in greater detail below. The processing system 800 further includes a device driver 814 and a memory management unit, such as an input/output memory management unit (IOMMU) 816. Components of processing system 800 are implemented as hardware, firmware, software, or any combination thereof. In some embodiments, the processing system 800 includes one or more software, hardware, and firmware components in addition to or different from those shown in FIG. 8.

Within the processing system 800, the system memory 806 includes non-persistent memory, such as dynamic random-access memory (not shown). In various embodiments, the system memory 806 stores processing logic instructions, constant values, variable values during execution of portions of applications or other processing logic, or other desired information. For example, in various embodiments, parts of control logic to perform one or more operations on CPU 802 reside within system memory 806 during execution of the respective portions of the operation by CPU 802. During execution, respective applications, operating system functions, processing logic commands, and system software reside in system memory 806. Control logic commands that are fundamental to operating system 808 generally reside in system memory 806 during execution. In some embodiments, other software commands (e.g., a set of instructions or commands used to implement a device driver 814) also reside in system memory 806 during execution of processing system 800.

The IOMMU 816 is a multi-context memory management unit. As used herein, context is considered the environment within which the kernels execute and the domain in which synchronization and memory management is defined. The context includes a set of devices, the memory accessible to those devices, the corresponding memory properties, and one or more command-queues used to schedule execution of a kernel(s) or operations on memory objects. The IOMMU 816 includes logic to perform virtual to physical address translation for memory page access for devices, such as the GPU 804. In some embodiments, the IOMMU 816 also includes, or has access to, a translation lookaside buffer (TLB) (not shown). The TLB is implemented in a content addressable memory (CAM) to accelerate translation of logical (i.e., virtual) memory addresses to physical memory addresses for requests made by the GPU 804 for data in system memory 806.

In various embodiments, the communications infrastructure 810 interconnects the components of the processing system 800. Communications infrastructure 810 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some embodiments, communications infrastructure 810 also includes an Ethernet network or any other suitable physical communications infrastructure that satisfies an application's data transfer rate requirements. Communications infrastructure 810 also includes the functionality to interconnect components, including components of the processing system 800.

A driver, such as device driver 814, communicates with a device (e.g., GPU 804) through an interconnect or the communications infrastructure 810. When a calling program invokes a routine in the device driver 814, the device driver 814 issues commands to the device. Once the device sends data back to the device driver 814, the device driver 814 invokes routines in an original calling program. In general, device drivers are hardware-dependent and operating-system-specific to provide interrupt handling required for any necessary asynchronous time-dependent hardware interface. In some embodiments, a compiler 818 is embedded within device driver 814. The compiler 818 compiles source code into program instructions as needed for execution by the processing system 800. During such compilation, the compiler 818 applies transforms to program instructions at various phases of compilation. In other embodiments, the compiler 818 is a standalone application. In various embodiments, the device driver 814 controls operation of the GPU 804 by, for example, providing an application programming interface (API) to software (e.g., applications 812) executing at the CPU 802 to access various functionality of the GPU 804.

The CPU 802 includes (not shown) one or more of a control processor, field-programmable gate array (FPGA), application-specific integrated circuit (ASIC), or digital signal processor (DSP). The CPU 802 executes at least a portion of the control logic that controls the operation of the processing system 800. For example, in various embodiments, the CPU 802 executes the operating system 808, the one or more applications 812, and the device driver 814. In some embodiments, the CPU 802 initiates and controls the execution of the one or more applications 812 by distributing the processing associated with one or more applications 812 across the CPU 802 and other processing resources, such as the GPU 804.

The GPU 804 executes commands and programs for selected functions, such as graphics operations and other operations that are particularly suited for parallel processing. In general, GPU 804 is frequently used for executing graphics pipeline operations, such as pixel operations, geometric computations, and rendering an image to a display. In some embodiments, GPU 804 also executes compute processing operations (e.g., those operations unrelated to graphics such as video operations, physics simulations, computational fluid dynamics, etc.), based on commands or instructions received from the CPU 802. For example, such commands include special instructions that are not typically defined in the instruction set architecture (ISA) of the GPU 804. In some embodiments, the GPU 804 receives an image geometry representing a graphics image, along with one or more commands or instructions for rendering and displaying the image. In various embodiments, the image geometry corresponds to a representation of a two-dimensional (2D) or three-dimensional (3D) computerized graphics image.

In various embodiments, the GPU 804 includes one or more compute units, such as one or more processing cores 820 (illustrated as 820-1 and 820-2) that include one or more single-instruction multiple-data (SIMD) units 822 (illustrated as 822-1 to 822-4) that are each configured to execute a thread concurrently with execution of other threads in a wavefront by other SIMD units 822, e.g., according to a SIMD execution model. The SIMD execution model is one in which multiple processing elements share a single program control flow unit and program counter and thus execute the same program but are able to execute that program with different data. The processing cores 820 are also referred to as shader cores or streaming multi-processors (SMXs). The number of processing cores 820 implemented in the GPU 804 is configurable. Each processing core 820 includes one or more processing elements such as scalar and or vector floating-point units, arithmetic and logic units (ALUs), and the like. In various embodiments, the processing cores 820 also include special-purpose processing units (not shown), such as inverse-square root units and sine/cosine units.

Each of the one or more processing cores 820 executes a respective instantiation of a particular work item to process incoming data, where the basic unit of execution in the one or more processing cores 820 is a work item (e.g., a thread). Each work item represents a single instantiation of, for example, a collection of parallel executions of a kernel invoked on a device by a command that is to be executed in parallel. A work item executes at one or more processing elements as part of a workgroup executing at a processing core 820.

The GPU 804 issues and executes work-items, such as groups of threads executed simultaneously as a “wavefront”, on a single SIMD unit 822. Wavefronts, in at least some embodiments, are interchangeably referred to as warps, vectors, or threads. In some embodiments, wavefronts include instances of parallel execution of a shader program, where each wavefront includes multiple work items that execute simultaneously on a single SIMD unit 822 in line with the SIMD paradigm (e.g., one instruction control unit executing the same stream of instructions with multiple data). A scheduler 824 is configured to perform operations related to scheduling various wavefronts on different processing cores 820 and SIMD units 822 and performing other operations to orchestrate various tasks on the GPU 804.

To reduce latency associated with off-chip memory access, various GPU architectures include a memory cache hierarchy (not shown) including, for example, L1 cache and a local data share (LDS). The LDS is a high-speed, low-latency memory private to each processing core 820. In some embodiments, the LDS is a full gather/scatter model so that a workgroup writes anywhere in an allocated space.

The parallelism afforded by the one or more processing cores 820 is suitable for graphics-related operations such as pixel value calculations, vertex transformations, tessellation, geometry shading operations, and other graphics operations. A graphics processing pipeline 826 accepts graphics processing commands from the CPU 802 and thus provides computation tasks to the one or more processing cores 820 for execution in parallel. Some graphics pipeline operations, such as pixel processing and other parallel computation operations, require that the same command stream or compute kernel be performed on streams or collections of input data elements. Respective instantiations of the same compute kernel are executed concurrently on multiple SIMD units 822 in the one or more processing cores 820 to process such data elements in parallel. As referred to herein, for example, a compute kernel is a function containing instructions declared in a program and executed on an accelerated processing device (APD) processing core 820. This function is also referred to as a kernel, a shader, a shader program, or a program.

In at least some embodiments, the processing system 800 is a computer, laptop/notebook, mobile device, gaming device, wearable computing device, server, or any of various other types of computing systems or devices. It is noted that the number of components of the processing system 800 varies from embodiment to embodiment. In at least some embodiments, there is more or fewer of each component/subcomponent than the number shown in FIG. 8. It is also noted that the processing system 800, in at least some embodiments, includes other components not shown in FIG. 8. Additionally, in other embodiments, the processing system 800 is structured in other ways than shown in FIG. 8.

In some embodiments, the apparatus and techniques described above are implemented in a system including one or more integrated circuit (IC) devices (also referred to as integrated circuit packages or microchips). Electronic design automation (EDA) and computer-aided design (CAD) software tools, in at least some embodiments, are used in the design of the standard cells and the design and fabrication of IC devices implementing the standard cells. These design tools typically are represented as one or more software programs. The one or more software programs include code executable by a computer system to manipulate the computer system to operate on code representative of circuitry of one or more IC devices to perform at least a portion of a process to design or adapt a manufacturing system to fabricate the circuitry. This code, in at least some embodiments, includes instructions, data, or a combination of instructions and data. The software instructions representing a design tool or fabrication tool typically are stored in a computer-readable storage medium accessible to the computing system. Likewise, the code representative of one or more phases of the design or fabrication of an IC device, in at least some embodiments, is stored in and accessed from the same computer-readable storage medium or a different computer-readable storage medium.

A computer-readable storage medium, in at least some embodiments, includes include any non-transitory storage medium or combination of non-transitory storage media accessible by a computer system during use to provide instructions and or data to the computer system. Such storage media, in at least some embodiments, includes, but is not limited to, optical media (e.g., compact disc (CD), digital versatile disc (DVD), Blu-ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium, in at least some embodiments, is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer-readable storage medium. The software, in at least some embodiments, includes the instructions and certain data that, when executed by the one or more processors, manipulate the one or more processors to perform one or more aspects of the techniques described above. The non-transitory computer-readable storage medium, in at least some embodiments, includes, for example, a magnetic or optical disk storage device, solid-state storage devices such as Flash memory, a cache, random access memory (RAM), or other non-volatile memory device or devices, and the like. The executable instructions stored on the non-transitory computer-readable storage medium, in at least some embodiments, is in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified, and all such variations are considered within the scope of the disclosed subject matter. Accordingly, the protection sought herein is as set forth in the claims below.

What is claimed is:

1. A method comprising:
determining, at a processor, a first distribution based on behavior associated with an artificial agent and a second distribution based on behavior associated with a user;
generating, at the processor, a similarity measurement by comparing the first distribution to the second distribution, wherein the similarity measurement quantifies a human-likeness of the behavior associated with the artificial agent; and
responsive to the similarity measurement failing to meet a similarity threshold, modifying, at the processor, the behavior of the artificial agent based on the similarity measurement.

2. The method of claim 1, wherein determining the first distribution and the second distribution comprises:
vectorizing a first set of behavior information to generate a first plurality of vectors, wherein each vector of the first plurality of vectors represents a different subsequence of behavior from the first set of behavior information; and
vectorizing a second set of behavior information to generate a second plurality of vectors, wherein each vector of the second plurality of vectors represents a different subsequence of behavior from the second set of behavior information.

3. The method of claim 2, wherein determining the first distribution and the second distribution further comprises:
transforming the first plurality of vectors into a first plurality of visual representations and the second plurality of vectors into a second plurality of visual representations.

4. The method of claim 2, wherein the first distribution comprises the first plurality of vectors and the second distribution the second plurality of vectors.

5. The method of claim 3, wherein the first distribution comprises the first plurality of visual representations and the second distribution comprises the second plurality of visual representations.

6. The method of claim 1, wherein generating the similarity measurement by comparing the first distribution to the second distribution comprises performing a two-sample hypothesis test.

7. The method of claim 6, wherein performing the two-sample hypothesis test comprises:
operating in a first mode comprising
evaluating over the first distribution and the second distribution separately to generate a first distribution of distances; and
generating a test statistic based on the first distribution of distances;
operating in a second mode comprising
combining the first distribution and the second distribution to generate a pooled sample distribution of behaviors; and
evaluating over the pooled sample distribution to generate a second distribution of distances; and
generating the similarity measurement based on the test statistic and the second distribution of distances.

8. The method of claim 7, wherein evaluating over the first distribution and the second distribution separately comprises:
for a given number of iterations, independently drawing a first subsample of a given size from the first distribution with replacement and a second subsample of the given size from the second distribution with replacement;
determining, for each iteration, a statistical distance between the first subsample and the second subsample; and
generating the first distribution of distances based on each statistical distance determined for each iteration.

9. The method of claim 8, wherein the test statistic is generated according to:
δ=quantile(δ_{X,Y},α) where α∈(0,1), where δ is the test statistic, δ_{X,Y} is the first distribution of distances, a is a hyperparameter for controlling a sensitivity of the two-sample hypothesis test, and
quantile(δ_{X,Y},α) returns the α-th quantile over the first distribution of distances.

10. The method of claim 8, wherein evaluating over the pooled sample distribution to generate a second distribution of distances comprises:
for the given number of iterations, independently drawing a third subsample of the given size from the pooled sample distribution with replacement and a fourth subsample of the given size from the pooled sample distribution;
determining, for each iteration, a statistical distance between the third subsample and the fourth subsample; and
generating the second distribution of distances based on each statistical distance determined for each iteration.

11. The method of claim 10, wherein the similarity measurement is generated as a percentage of the distances in the second distribution of distances with a distance that is greater than the test statistic.

12. The method of claim 1, wherein modifying the artificial agent based on the similarity measurement modifies one or more behaviors of the artificial agent.

13. An apparatus comprising:
a processor configured to:
determine a first distribution based on a behavior associated with an artificial agent and a second distribution based on a behavior associated with a user;
generate a similarity measurement by comparing the first distribution to the second distribution, wherein the similarity measurement quantifies a human-likeness of the behavior associated with the artificial agent; and
responsive to the similarity measurement failing to meet a similarity threshold, modify the behavior of the artificial agent based on the similarity measurement.

14. The apparatus of claim 13, wherein the processor is configured to generate the similarity measurement by:
operating in a first mode comprising
evaluating over the first distribution and the second distribution separately to generate a first distribution of distances; and
generating a test statistic based on the first distribution of distances;
operating in a second mode comprising
combining the first distribution of behavior and the second distribution of behavior to generate a pooled sample distribution of behaviors; and
evaluating over the pooled sample distribution to generate a second distribution of distances; and
generating the similarity measurement based on the test statistic and the second distribution of distances.

15. The apparatus of claim 14, wherein the processor is configured to evaluate over the first distribution and the second distribution separately by:
for a given number of iterations, independently drawing a first subsample of a given size from the first distribution with replacement and a second subsample of the given size from the second distribution with replacement;
determining, for each iteration, a statistical distance between the first subsample and the second subsample; and
generating the first distribution of distances based on each statistical distance determined for each iteration.

16. The apparatus of claim 15, wherein the processor is configured to evaluate over the pooled sample distribution to generate a second distribution of distances by:
for the given number of iterations, independently drawing a third subsample of the given size from the pooled sample distribution with replacement and a fourth subsample of the given size from the pooled sample distribution;
determining, for each iteration, a statistical distance between the third subsample and the fourth subsample; and
generating the second distribution of distances based on each statistical distance determined for each iteration.

17. The apparatus of claim 15, wherein the processor is configured to generate the similarity measurement as a percentage of the distances in the second distribution of distances with a distance that is greater than the test statistic.

18. A method comprising:
determining a first distribution based on behavior associated with a first artificial agent and a second distribution based on behavior associated with a second artificial agent;
generating a similarity measurement by comparing the first distribution to the second distribution, wherein the similarity measurement quantifies a similarity between the behavior of the first artificial agent and the behavior of the second artificial agent; and
modifying, based on the similarity measurement, at least one of the behavior of the first artificial agent or the behavior of the second artificial agent.

19. The method of claim 18, wherein the behavior of the first artificial agent is represented by a first episode defined as a first sequence of behaviors spanning an initial state to a terminal state of the first artificial agent, and wherein the behavior of the second artificial agent is represented by a second episode defined as a second sequence of behaviors spanning an initial state to a terminal state of the second artificial agent.

20. The method of claim 19, wherein determining the first distribution and the second distribution comprises:
sampling a first plurality of trajectories from the first episode, wherein each trajectory of the first plurality of trajectories is a subsequence of the first sequence of behaviors;
sampling a second plurality of trajectories from the second episode, wherein each trajectory of the second plurality of trajectories is a subsequence of the second sequence of behaviors;
vectorizing each sample trajectory of the first plurality of trajectories to generate a first plurality of vectors; and
vectorizing each sample trajectory of the second plurality of trajectories to generate a second plurality of vectors,
wherein the first distribution of behavior is determined based on the first plurality of vectors and the second distribution is determined based on the second plurality of vectors.
